(19) United States
(12) Patent Application Publication
(10) Pub. No.: US 2026/0179323 A1
(43) Pub. Date: Jun. 25, 2026

(54) VOLUME MESH GENERATION

(71) Applicant: Siemens Industry Software Inc., Plano, TX (US)

(72) Inventors: Davide Detomi, Roma (IT); Scott Canann, Austin, TX (US); Kenneth Blake, Austin, TX (US)

(21) Appl. No.: 19/124,406

(22) PCT Filed: Nov. 10, 2022
(86) PCT No.: PCT/US2022/049491

§ 371 Date: Apr. 25, 2025

(51) Int. Cl. G06T 17/20

(52) U.S. Cl. CPC G06T 17/20

(57) ABSTRACT

A computer-implemented method of generating a volume mesh between two proximate, disjoint, and opposing mesh surfaces of a three-dimensional object in a modelling system is described. In the method, a projected volume is determined, wherein a mesh volume having a first topology is generated when the volume reaches the opposing mesh surfaces within a distance determined by the local mesh size. A second volume mesh with a different topology is generated when the projected volume does not reach the opposing mesh surface.

The present patent document is a § 371 nationalization of PCT Application Serial No. PCT/US2022/049491, filed Nov. 10, 2022, designating the United States, which is hereby incorporated by reference in its entirety.

### TECHNICAL FIELD

The present disclosure relates to a computer-implemented method of generating a volume mesh between two proximate, disjoint, and opposing mesh surfaces of a three-dimensional object in a modelling system, where the mesh surfaces are separated by a distance t, and where the modelling system is configured to render an image of the object including the meshed surfaces to a user.

### BACKGROUND

Computer-aided modelling techniques, such as CAD (computer-aided design), CAE (computer-aided engineering) and CAx (computer-aided technologies in general), are used frequently in the design of engineering products, from automotive and aeronautical components to electronic devices. While a number of techniques are used, one with application in both rendering images to a computer screen and in physical simulation is mesh generation. A mesh may be defined as the subdivision of a continuous geometric space into discrete geometric and topological cells. This applies equally to surface and volumes, where in both cases the aim of mesh generation is to create a mesh that captures input domain geometry accurately with a high-quality mesh, but without requiring a very large number of calculations to do so. A high-quality mesh is one where not only are the individual cells well shaped but are also small in size to maintain the accuracy of subsequent calculations during rendering or simulation activities. For example, a high-quality triangular mesh may have cells with a shape as close as possible to an equilateral triangle, since an isosceles or right-angled triangle with one highly acute apex may create regions lacking in uniformity within a surface or volume. In particular, small angles may cause issues if a stretched triangle is randomly oriented. A squeezed triangle where one apex is moved towards the opposite edge thus creating one very large and two very small angles may also be critical. In the case of a volume mesh, this is generated to quickly fill spaces between surfaces within a CAD model. The volume mesh may be anisotropic (such as a prismatic volume mesh based upon a triangular prism) or isotropic (such as a cubic volume mesh).

One application of meshing is in the modelling of surfaces that are in proximity to one another. As an example of this, FIG. 1 illustrates a portion of a perspective view of the framework of ribs and spars in an airplane wing. Each of the ribs 1 and spars 2 of the airplane wing 3 is made of a thin sheet of material, modelled by using surface meshes representing each of the closely-spaced surfaces of the thin sheet. For a single rib 1, each surface is in proximity to the other, meaning that any volume fill between the mesh surfaces will need to be created using a so-called thin meshing technique. This is where the local geometry of a point on a surface is classed as “thin” due to the mesh size in that locality. The aim is to create topologically equivalent, or matching meshes across the thin regions, such that high-quality prismatic volume meshes may be generated to fill the space between the proximate surfaces. The prisms generated in such prismatic volume meshes are highly susceptible to favoring potentially skewed tetrahedra, which may lead to accuracy and conditioning issues during subsequent numerical analysis. The detection of thin model features requires a careful proximity analysis, traditionally performed by projecting rays from the vertices of the surface mesh using the local surface normal and finding the first intersection with a proximate surface mesh. The assumption is that the distance between the source and target points on the two surface meshes may be considered a measure of the proximity between the two surfaces, and therefore the most important information to use to judge the local model thinness.

Being able to determine where two mesh surfaces are in proximity is useful for many reasons, including driving mesh sizing determination where ethe surfaces are in proximity, in order to avoid poor volume mesh generation. While the standard ray-based approach is reasonable for mesh sizing, it is too simplistic for applications such as thin meshing.

The issues with standard ray-based methods are illustrated in more detail in FIGS. 2a and 2b. FIG. 2a is a schematic illustration of curved proximate mesh surfaces. A first mesh surface 10 including a plurality of mesh vertices 11a . . . n and mesh faces 12a . . . n forms an upper surface of an object. A second mesh surface 13 including a plurality of mesh vertices 14a . . . n each and mesh faces 15a . . . n forms the lower surface of an object, with the second mesh surface 13 being proximate to the first mesh surface 10. Both of these proximal surfaces have a large curvature, such that the normal direction is highly sensitive to the local discretization and may lead to non-optimal projections. Projecting a ray R from the vertex 11c at the local surface normal N at the turning point in the first mesh surface 10 leads to a ray that intersects the second mesh surface 13 away from a vertex 14c at the turning point of the second mesh surface 13. Although the vertex 14c is nearby, it is not directly in the path of the local normal N, and no snapping mechanism exists to snap the ray R at the vertex 14c.

Similarly, FIG. 2b is a schematic illustration of proximate mesh surfaces having sharp edges. A first mesh surface 16 including a plurality of mesh vertices 17a . . . n and mesh faces 18a . . . n forms an upper surface of an object. A second mesh surface 19 including a plurality of mesh vertices 20a . . . n and mesh faces 21a . . . n forms the lower surface of an object, with the second mesh surface 13 being proximate to the first mesh surface 16. Both of these proximal surfaces have regions of sharp corners A and B, such that the normal direction is highly sensitive to the local discretization and may again lead to non-optimal projections. Projecting a ray R from the vertex 17b at the local surface normal N at a first corner A in the first mesh surface 16 leads to a ray that intersects the second mesh surface 19 away from the vertex 20b of the second mesh surface 19. Although the vertex 20b is nearby, it is not directly in the path of the local normal N, and no snapping mechanism exists to snap the ray R at the vertex 20b. Projecting a ray R from the vertex 20c at the local surface normal N at a second corner B in the second mesh surface 16 leads to a ray that intersects the first mesh surface 16 away from the vertex 17c of the first mesh surface 16. Although the vertex 17c is nearby, it is not directly in the path of the local normal N, and no snapping mechanism exists to snap the ray R at the vertex 17b. It would be desirable, therefore, to be able to use a more sophisticated approach to discover the proximal regions of real-world complex industrial geometries. This would lead to increased accuracy in subsequent numerical simulations based on the generated mesh.

### SUMMARY

The present disclosure aims to address these issues, in a first aspect, by providing a computer-implemented method of generating a volume mesh between two proximate, disjoint, and opposing mesh surfaces of a three-dimensional object in a modelling system, wherein the modelling system is configured to render an image of the object including the meshed surfaces to a user. The method includes: a) selecting a source point S lying on one of the two mesh surfaces; and b) projecting a volume centered at the source point S along an axis corresponding to the surface normal N at the source point S. Additionally, when the projected volume meets the opposing mesh surface along its axis within a distance determined by the value of the ratio t/LS, where LS is the local mesh size at the source point S and t is the distance between the two mesh surfaces at the source point S, the method further includes: c) determining, within the region, the closest intersection point T on the opposing mesh surface to the source point S; and d) generating a first volume mesh between the two proximate and opposing mesh surfaces using the closest intersection point T and the source point S as vertices. Further, when the projected volume does not meet the opposing mesh surface along its axis within a distance determined by the value of the ratio t/LS, the method includes: e) generating a second, different topology, volume mesh between the two proximate and opposing mesh surfaces.

The advantage of such an approach is that while structure meshes commonly provide many advantages in numerical simulations in terms of optimal accuracy with a smaller number of cells as compared to standard meshes, these are much more difficult to construct automatically without user intervention. The intelligent placement of targets with respect to their corresponding sources in accordance with embodiments of the present disclosure is critical and is a key area where known methods struggle with robustness.

The first volume mesh may be a prismatic volume mesh and the second volume mesh may be an isotropic volume mesh.

The source point S may lie at a vertex of the mesh surface.

The method may further include repeating acts a) to e) for all other vertices in the mesh surface. In this situation, the volume may be a cone having an apex at the source point S, wherein the cone is generated by projecting a ray along the surface normal N at the source point S and generating an apex angle α as a function of the local mesh size.

In certain examples, act c) may include: exploring the opposing mesh surface within the cone by projecting the ray k times, such that the closest intersection point T is either an initial closest intersection point T⁰ or a new intersection point T^{k} that lies closer to the source point S than the initial closest intersection point T⁰ and obtained on the k^{th} ray projection.

The vertex may be located at a change in direction of the mesh surface.

In certain examples, when the closest intersection point T on the opposing mesh surface lies within a pre-determined threshold distance of an adjacent mesh edge or vertex of the opposing mesh surface, the closest intersection point T may be moved to the adjacent mesh edge or vertex.

In certain examples, when the source point S is bounded by n mesh vertices, the method may further include: selecting each vertex in turn as a source point Sₙ; and repeating acts a) to d) for each source point Sₙ to determine the closest intersection point Tₙ.

The magnitude of the vector ∥T−S∥ may be given by the value of the ratio t/LS within a given tolerance of mesh size, where LS is the local mesh size at the source point S and t is the distance between the two mesh surfaces at the source point S.

The projected volume may be a cylinder.

The source point S may be located on a mesh edge or within a mesh face.

In a second aspect, the present disclosure also provides a data processing system configured to generate a volume mesh between two proximate, disjoint and opposing mesh surfaces of a three-dimensional object in a modelling system. The data processing system includes a processor configured to: select a source point S lying on one of the two mesh surfaces; and project a volume centered at the source point S along an axis corresponding to the surface normal N at the source point S. When the projected volume meets the opposing mesh surface along its axis within a distance determined by the value of the ratio t/LS, where LS is the local mesh size at the source point S and t is the distance between the two mesh surfaces at the source point S, the processor is further configured to: determine, within the region, the closest intersection point T on the opposing mesh surface to the source point S; and generate a first volume mesh between the two proximate and opposing mesh surfaces using the closest intersection point T and the source point S as vertices. Additionally, when the projected volume does not meet the opposing mesh surface along its axis within a distance determined by the value of the ratio t/LS, the processor is configured to generate a second, different topology, volume mesh between the two proximate and opposing mesh surfaces. The data processing system further includes a display configured to display a rendered image of the object including the meshed surfaces to a user.

The first volume mesh may be a prismatic volume mesh and the second volume mesh may be an isotropic volume mesh.

In a third aspect, the present disclosure also provides a computer program product including instructions that, when the instructions are executed by a computer, cause the computer to carry out the acts of the method outlined above.

### BRIEF DESCRIPTION OF THE DRAWINGS

The present disclosure is now described by way of example only, and with reference to the accompanying drawings, in which:

FIG. 1 illustrates an example of a portion of a perspective view of the framework of ribs and spars in an airplane wing.

FIG. 2a depicts an example of a schematic illustration of curved proximate mesh surfaces.

FIG. 2b depicts an example of a schematic illustration of proximate mesh surfaces having sharp edges.

FIG. 3 illustrates an example of the basic manner in which it may be determined whether two mesh surfaces lie in proximity.

FIG. 4a depicts an example of a schematic illustration of mesh face surface normal.

FIG. 4b depicts an example of a schematic illustration of the corresponding mesh vertex normal to the mesh surface normal of FIG. 4a.

FIG. 5 depicts an example of a schematic illustration of two proximate and opposing mesh surfaces for which the proximity of the mesh surfaces to one another needs to be explored.

FIG. 6 depicts an example of a flowchart illustrating the acts of a method.

FIGS. 7a to 7c illustrate examples of the application of a method in accordance with an embodiment to a pair of opposing, proximate mesh surfaces forming a double 90° elbow pipe.

FIG. 7d depicts an example of a schematic illustration of the results of the application of the method in FIGS. 7a to 7c.

FIGS. 8a to 8d illustrate examples of the application of a method in accordance with an embodiment to a pair of opposing, proximate mesh surfaces forming a double 90° elbow pipe with a corner cut.

FIG. 8e depicts an example of a schematic illustration of the results of the application of the method in FIGS. 8a to 8d.

FIGS. 9a to 9b illustrate examples of the application of a method in accordance with an embodiment to a pair of opposing, proximate mesh surfaces forming a double sharp elbow pipe.

FIG. 9c depicts an example of a schematic illustration of the results of the application of the method in FIGS. 9a to 9b.

FIGS. 10a to 10c illustrate examples of the application of a method in accordance with an embodiment to a pair of opposing, proximate mesh surfaces forming a double sharp elbow pipe with a bottom shift.

FIG. 10d depicts an example of a schematic illustration of the results of the application of the method in FIGS. 10a to 10c.

FIGS. 11a to 11c illustrate examples of the application of a method in accordance with an embodiment to a pair of opposing, proximate mesh surfaces forming a sharp-smooth elbow pipe.

FIG. 11c depicts an example of a schematic illustration of the results of the application of the method in FIGS. 11a to 11b.

FIGS. 12a to 12b illustrate examples of the application of a method in accordance with an embodiment to a pair of opposing, proximate mesh surfaces forming a smooth-smooth elbow pipe.

FIG. 12c depicts an example of a schematic illustration of the results of the application of the method in FIGS. 12a to 12b.

FIGS. 13a to 13b illustrate examples of the application of a method in accordance with an embodiment to a pair of opposing, proximate mesh surfaces forming a smooth-smooth elbow pipe where one of the mesh surfaces has been shifted with respect to the other.

FIG. 13c depicts an example of a schematic illustration of the results of the application of the method in FIGS. 13a to 13b.

FIGS. 14a to 14c illustrate examples of the effect of angle on convergent-divergent surfaces and identifying whether a mesh is locally thin.

FIGS. 15a to 15d depict examples of opposing mesh surfaces having mirrored sharp angles.

FIG. 16 illustrates an example of a data processing system in which an embodiment of the present disclosure may be implemented, for example, a CAD system configured to perform processes as described herein.

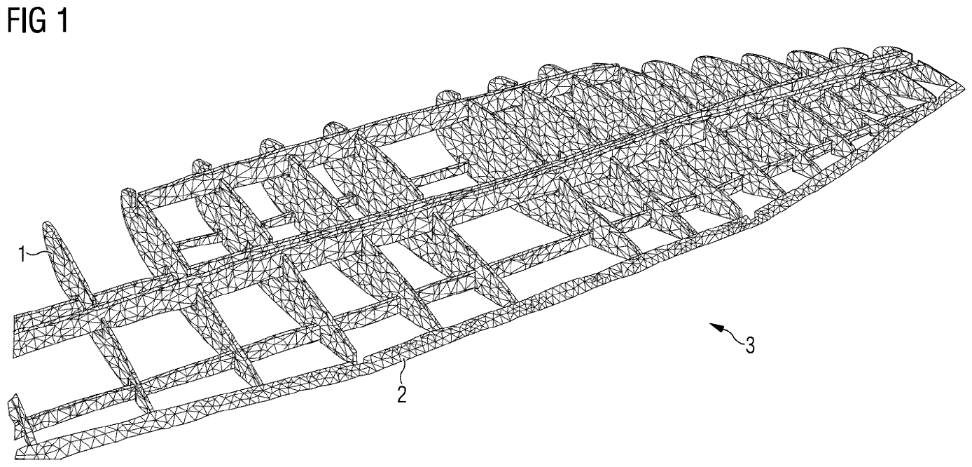

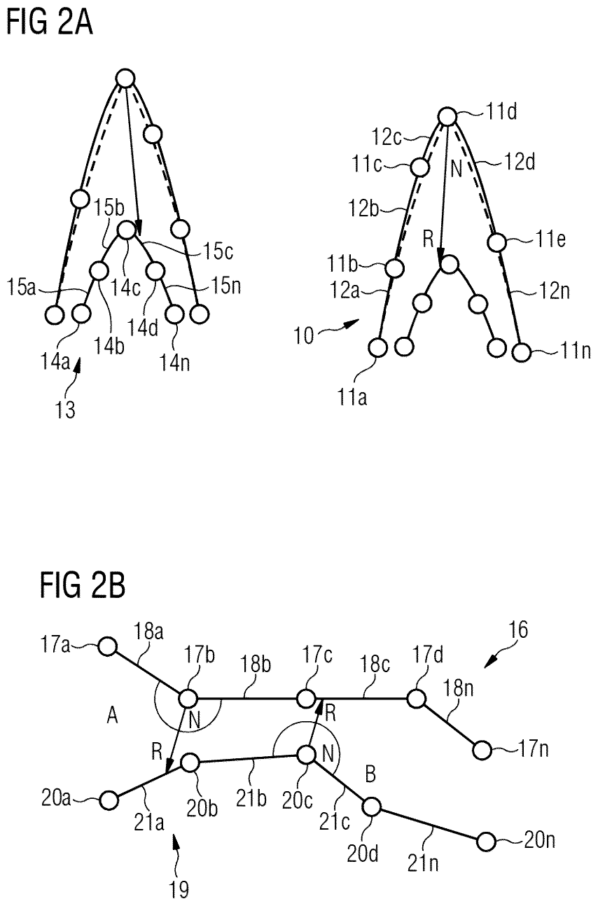

### DETAILED DESCRIPTION

The following notation and terminology are used in the description of the embodiments below.

Sᵢ(0≤i≤Nᵥₑᵣₜₛ) is the i^{th} source vertex from which a proximity exploration may be initiated, where the total number of vertices in the mesh surface is Nᵥₑᵣₜₛ.

dᵢ is the number of directions associated with a given source point, and in general, source points Sᵢ shared by mesh faces defining high dihedral angles corresponding to high curvatures in the original CAD model may be associated with dᵢ>1 directions.

$${F}_{i}^{d}$$

is the mesh race subset defining the d^{th} direction associated with Sᵢ.

$${r}_{i}^{d}$$

is the ray originating at the source point Sᵢ along the d^{th} direction.

K_{id} is an index referring to the last target point Tᵢ associated with Sᵢ and its d^{th} direction, and reflects the ability of the algorithm to search the optimal location with respect to some desirable properties, such as closeness, orthogonality, and automatic snapping.

$${T}_{id}^{k} ( 0 \leq i \leq {N}_{verts} , 0 \leq d < {D}_{i} , 0 \leq k \leq {K}_{id} )$$

is the kth target point referring to the d^{th} direction associated with the source point Sᵢ, with the initial target point

$${T}_{id}^{0}$$

being given by the closest intersection between the mesh surface and the ray r_{id}. If the only relevant target point is the final target point

$${T}_{id}^{k}$$

the other target points for values of k<K_{id} may be considered to understand the target point selection mechanism.

The embodiments described below are particularly effective when used in proximity detection for thin mesh generation. The approach taken is able to return the closest target point from a given source point for real-world arbitrary geometries. This then aids in maximizing the orthogonality between a ray and the target surface, which leads to the generation of high-quality prismatic meshes in the thin region. A reliable answer to two questions is obtained: firstly, what mesh vertices are in proximity to some facing mesh surface (thus detecting the thin sections of the CAD model); and secondly, for each thin vertex (source), is it possible to find a corresponding point over the facing surface (target) such that the source target pairs may effectively represent the preliminary act for the following generation of high-quality prismatic mesh in the thin section. This is done using a computer-implemented method of generating a volume mesh between two proximate, disjoint and opposing mesh surfaces of a three-dimensional object in a modelling system. The mesh surfaces are separated by a distance t, and the modelling system is configured to render an image of the object including the meshed surfaces to a user. The method initially includes selecting a source point S lying on one of the two mesh surfaces. Which mesh surface is chosen does not matter as long as both meshes are laying proximate to one another. Next, a volume centered at the source point S is projected along an axis corresponding to the surface normal at the source point S. If the projected volume meets the opposing mesh surface along its axis within a distance determined by the value of the ratio t/LS, where LS is the local mesh size at the source point S, the method will generate a first volume mesh, such as a prismatic volume mesh. This is done by determining, within the region, the closest intersection point T on the opposing mesh surface to the source point S, and then generating first volume mesh between the two proximate and opposing mesh surfaces using the closest intersection point T and the source point S as vertices. Alternatively, if the projected volume does not meet the opposing mesh surface along its axis within a distance determined by the value of the ratio t/LS, a second, different topology, volume mesh, such as an isotropic volume mesh is generated between the two proximate and opposing mesh surfaces.

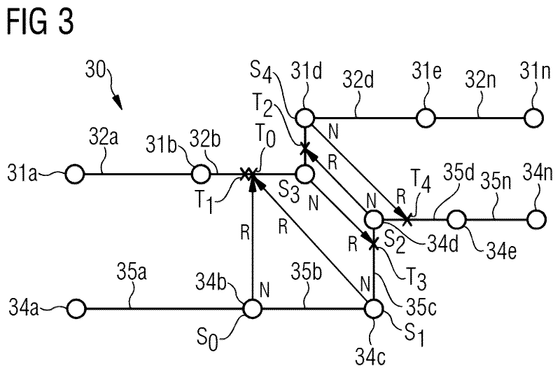

FIG. 3 illustrates the basic manner in which whether or not two mesh surfaces lie in proximity may be determined. FIG. 3 is a schematic representation of two proximate mesh surfaces illustrating a number of ray tracing issues. A first mesh surface 30 having a number of vertices 31a . . . n linked together by mesh faces 32a . . . n is positioned proximate to a second mesh surface 33, also having a number of vertices 34a . . . n linked together by mesh faces 35a . . . n. Initially, to determine whether the first 30 and second 33 surfaces actually lie in proximity, it is necessary to define a suitable set of vertices as source points S and to project rays R from each of these source points S along directions that may be set reasonably as the surface normal N at each source point location. For source points S corresponding to mesh vertices 31a . . . n, 34a . . . n, each ray R direction may be given as:

$${n}_{i} = {\sum }_{j}^{N} {w}_{j} {n}_{ij}$$

where nᵢⱼ are the face normals of the N faces sharing the i^{th} vertex and wⱼ are suitable weights, such as:

$${w}_{j} = \frac{{A}_{j}}{{\sum }_{j} {A}_{j}}$$

where Aj is the area of the j^{th} face.

Starting with the second vertex 34b of the second surface 33 in FIG. 3 as a first source point S₀, a ray R is projected outwards towards the first surface 30 along the surface normal N at S₀. The second vertex 34b is shown as being located in a region where the angle between the mesh faces 35a, 35b is 180°. The ray R meets the first mesh surface 30 on a mesh face 32b, such that the target point T₀ intersects the first mesh surface 30 at a mesh face 32b. Taking a second vertex 34c located at an abrupt change in direction of the second mesh surface 33 (the mesh faces 35b, 35c are positioned with an angle of 90 between them) as a second source point S₁, again a ray R is projected out from Sᵢ along the surface normal direction N at Sᵢ towards the first mesh surface 30. Again, the target point T₁ is located in the middle of a mesh face 32b and is clearly not the closest point on the first mesh surface 30 to the source point S₁. In addition, rays from the first S₀ and second Sᵢ source points clash just before reaching the first mesh surface 30. Taking a third source point S₂ as a vertex 34d in the second mesh surface 33, this time being located at an abrupt change in direction of the second mesh surface 33 where the mesh faces 35c, 35d are positioned at an angle of 270° to each other, again, a ray R projected along the surface normal N at S₂ intersects the first mesh surface 30 at a target point T₂ in the middle of a mesh face 32c. Starting from the first mesh surface 30 by selecting source points S₃ and S₄ at vertices 31b, 31c located again at abrupt turning points in the first mesh surface 30 also results in rays R projected along the surface normal N intersecting with target points T₃, T₄ located in the mesh faces 35c, 35d on the second mesh surface 33.

This method is fast and effective whenever the only information sought is if the surfaces are more or less close to each other, as derived from the distance ∥T−S∥ and works well whenever the curvature of the mesh surfaces is small on both sides. This is illustrated by the source-target pair S₀→T⁰ in FIG. 3. However, for thin meshing the specific location of the target point T is an important factor to consider, hence there are some issues with the basic method outlined in FIG. 3. Firstly, there is no mechanism to prevent opposing projections, such as S₀→T⁰ and S₁→T₁ from becoming tangled. Secondly, it is expected that the projection targets will miss the corners or sharp edges of abrupt changes in direction of the mesh surface if no explicit snapping mechanism is implemented, such as S₂→T₂, S₃→T₃ and S₄→T₄. Implementing a robust and reliable snapping mechanism in this situation would be complex in all possible use cases, which renders this unsuitable for thin meshing. Thirdly, if the location of the target point T is important, other properties need to be taken into consideration. One example of this is how close is the incoming vector to the local surface normal (the orthogonality property). The method of FIG. 3 cannot enforce any desirable property at the target point T, since it is only based on data referring to the source point S.

In the following examples, an assumption is made that all source points S are mesh vertices. The mesh vertex surface normals N are given by a weighted surface normal that is calculated as follows. The set of N mesh vertex faces (Fᵢ) sharing each source point Sᵢ is split into Dᵢ subsets (where for Fdᵢ, 0≤d<Dᵢ). All of the mesh faces belonging to a given subset share at least one edge with another face within the same subset. In addition,

$${F}_{i} = {U}_{d}^{Di} {F}_{i}^{d} and {F}_{i}^{d 1} ∩ {F}_{i}^{d 2} , = ∅$$

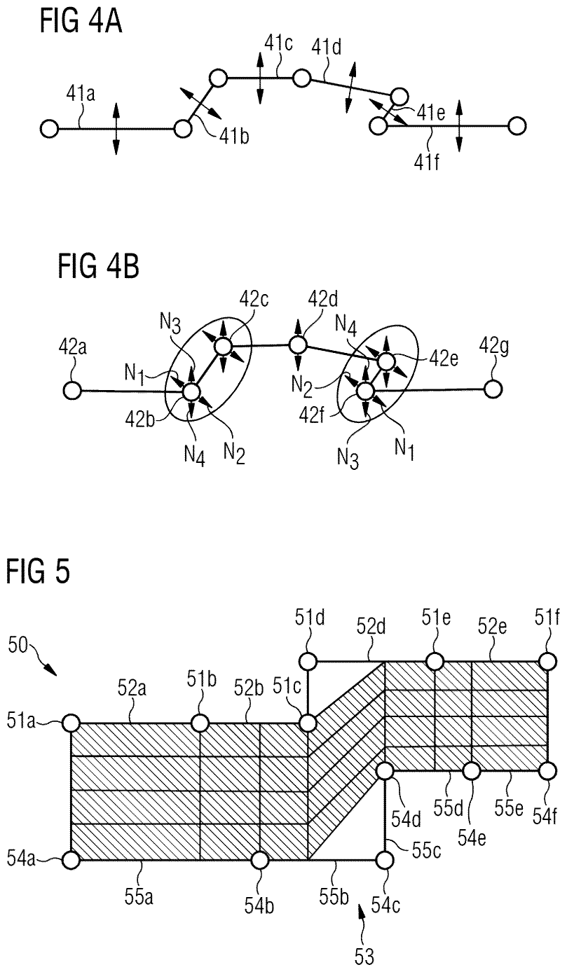

with 0≤dᵢ, d₂<Dᵢ. Any mesh edge may share at most two mesh faces within the same subset, such that non-manifold mesh edges sharing more than two mesh faces cannot have more than two mesh edge faces contained by the same subset. Whenever a mesh edge is non-manifold or is sufficiently sharp with respect to a given threshold, multiple surface normal will be assigned to both of the endpoints of the mesh edge. Moreover, to provide a complete space exploration around each source point S, any computed surface normal N will be duplicated by including its opposite direction. This is illustrated further in FIGS. 4a and 4b.

FIG. 4a is a schematic illustration of mesh face surface normals. Despite the relatively complex shape of the mesh surface 40, each of the mesh face surface normals at the center of each mesh face 41a-f may be duplicated such that a proximity search may take place in the opposite direction. FIG. 4b is a schematic illustration of the corresponding mesh vertex normals to the mesh surface normals of FIG. 4a. Within the complex mesh surface 40, there is a single mesh vertex 42d between mesh faces 41c, 41d defining a low dihedral angle, such that only one subset of surface normals N₁, N₂ is calculated. However, there are four examples of mesh vertices 42b, 42c, 42e, 42f that sit between mesh faces 41b, 41c, 41e, 41f where a high dihedral angle is defined, creating a sharp corner or abrupt change in direction of the mesh surface. For each of these mesh vertices 42b, 42c, 42e, 42f, two subsets of surface normals N₁, N₂ and N₃, N₄ are calculated. This is because it is possible to consider a mesh vertex normal in relation to each of the two mesh faces the mesh vertex sits between, hence each represents a possibility for proximity exploration.

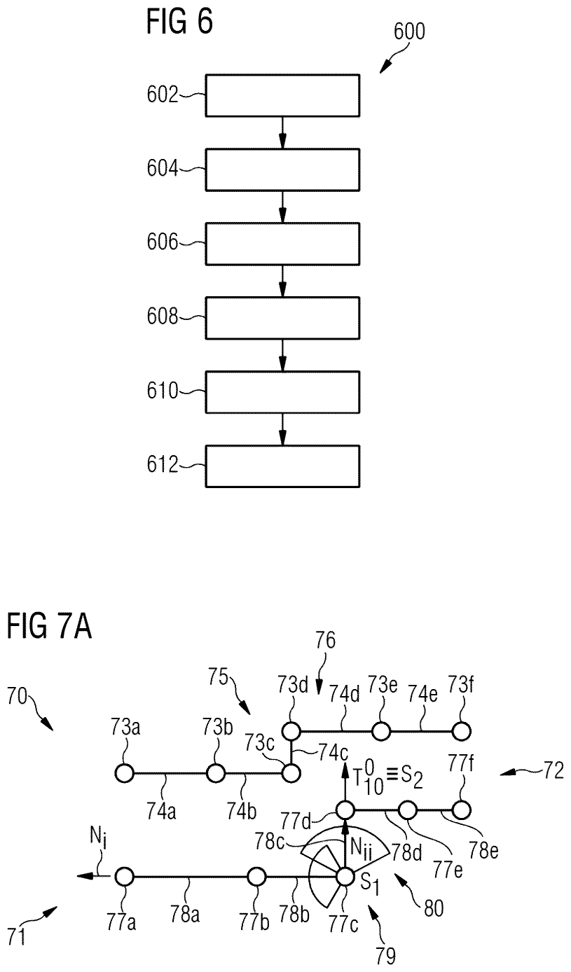

The method of embodiments is now described in more detail, with reference to FIG. 5, which is a schematic illustration of two proximate and opposing mesh surfaces for which the proximity of the mesh surfaces to one another needs to be explored, and with reference to FIG. 6, which is a flowchart illustrating the acts of a method in accordance with the embodiments.

In FIG. 5, a first mesh surface 50, including a number of mesh vertices 51a-f linked by a number of mesh faces 52a-e sits in the region of a second mesh surface 53 including a number of mesh vertices 54a-f linked by a number of mesh faces 55a-e. The two mesh surfaces 50, 53 are proximate and opposing. Each of the first 50 and second 53 mesh surfaces includes two regions where a mesh vertex 51c, 51d, 54c, 54d is positioned between mesh faces 52b, 52c, 52d, 55b, 55c, 55d defining a high dihedral angle. This creates an abrupt change in direction of the first 50 and second 53 mesh surfaces resulting in a dihedral angle of 90°.

Turning now to FIG. 6, and with reference to FIG. 5, a method 600 in accordance with embodiments beginning, at act 602, by selecting a source point S lying on one of the two mesh surfaces 50, 53. The source point S may be located on a mesh edge, within a mesh face, or at a mesh vertex. This is illustrated in FIG. 5, where the source point S is located on a mesh vertex 54c.

Next, at act 604, a volume centered at the source point S is projected along an axis corresponding to the surface normal N at the source point S. In the example shown in FIG. 5, the volume is a cone 56 having an apex at the source point S, where the cone i56 is generated by projecting a ray r along the surface normal N at the source point S and generating an apex angle α as a function of the local mesh size LS. The local mesh size LS at the source point S is determined by the spacing of the mesh vertices 51a-f, 54a-f. While, in this example. the projected volume is a cone, it may be desirable to use an alternative volume, such as a cylinder.

If the projected volume meets the opposing mesh surface 50 along its axis within a distance determined by the value of the ratio t/LS, where LS is the local mesh size at the source point S and t is the distance between the two mesh surfaces at the source point S, then at act 606, the closest intersection point, or target point, T on the opposing mesh surface 50 to the source point S is determined.

At act 608, a first volume mesh is then generated between the two proximate and opposing mesh surfaces 50, 53 using the closest intersection point T and the source point S as vertices. The first volume mesh may be a prismatic volume mesh.

If the projected volume does not meet the opposing mesh surface 50 along its axis within a distance determined by the value of the ratio t/LS, then, at act 610, a second, different topology, volume mesh is generated between the two proximate and opposing mesh surfaces 50, 51. The second volume mesh may be an isotropic volume mesh or a tetrahedral volume mesh. The magnitude of the vector ∥T−S∥ is given by the valued of the ratio t/LS within a given tolerance of the local mesh size. The tolerance may be determined by the user as a percentage of the local mesh size or as an absolute value.

Depending on the application, the method 600 may further include act 612, which includes repeating acts 602 to 610 for all other vertices in the mesh surface. In addition, if the closest intersection point T on the opposing mesh surface 50 lies within a pre-determined threshold distance of an adjacent mesh edge or vertex of the opposing mesh surface, the closest intersection point T is moved to the adjacent mesh edge or mesh vertex. The process of determining the closest intersection point T on the opposing mesh 50 in act 606 includes exploring the opposing mesh surface within the cone by projecting the ray r k times, such that the closest intersection point T is either an initial closest intersection point T⁰ or a new intersection point T^{k} that lies closer to the source point S than the initial closest intersection point T′ and obtained on the k^{th} ray projection. The application of the method 600 to a range of examples will now be described.

### 1. Double 90° Elbow Pipe

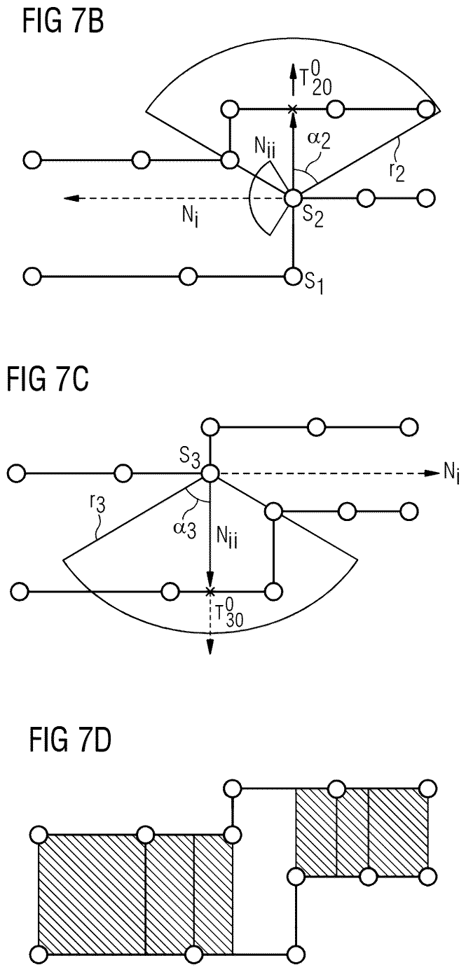

FIGS. 7a to 7c illustrate the application of a method in accordance with an embodiment to a pair of opposing, proximate mesh surfaces forming a double 90° elbow pipe, and FIG. 7d is a schematic illustration of the results of the application of the method in FIGS. 7a to 7c. In each of FIGS. 7a to c, a pair of proximate, opposing mesh surfaces 70, 71 in a double 90° elbow pipe 72 are shown. The first mesh surface 70 includes a number of mesh vertices 73a-f linked together by mesh faces 74a-e and having a first 90° elbow 75 at a mesh vertex 73c and a second 90° elbow 76 at a mesh vertex 73d. The second mesh surface 71 includes a number of mesh vertices 77a-f linked together by mesh faces 78a-e and having a first 90° elbow 79 at a mesh vertex 77c. The first 90° elbows 75, 79 and second 90° elbows 76, 80 are located adjacent to one another such that the double 90° elbow pipe 72 has a locally altered diameter within the region of the first 90° elbows 75, 79 and second 90° elbows 76, 80, but is continuous without a break along its length as shown. Source points S for exploration of the double 90° elbow region are chosen based on the mesh vertices that border the region itself.

Taking FIG. 7a, a first source point S1 is selected as the mesh vertex 77c forming the first 90° elbow 80 in the second mesh surface 71. There are two surface normals N_{i, ii} associated with the first source point S1: the first is along the mesh face 78b, pointing away from the double 90° double elbow region, and the second is along the mesh face 78c pointing towards the second 90° elbow 80 on the second mesh surface 71. Taking the first surface normal Nᵢ, there is no valid intersection with the first mesh surface 70 within the valid range given by the ratio of the distance t between the first 70 and second 71 mesh surfaces at the first source point S₁ and the local mesh size LS at the first source point S₁. Taking the second surface normal Nᵢᵢ, the only valid intersection with any mesh surface is in fact by snapping to the mesh vertex 77d on the second mesh surface 71, since this is very close to the valid range defined by the ratio t/LS, and therefore within a small tolerance of this valid range.

Taking FIG. 7b, a second source point S₂ is selected as the mesh vertex 77d forming the second 90° elbow 80 in the second mesh surface 71. There are two surface normals N_{i, ii} associated with the first source point S₂: the first is parallel to the mesh face 74b, pointing away from the double 90° double elbow region, and the second is perpendicular to the mesh face 74e pointing away from the second 90° elbow 80 on the second mesh surface 71. Taking the first surface normal Nᵢ, there is no valid intersection with the first mesh surface 70 within the valid range given by the ratio t/LS, since this surface normal Ni lies within the space separating the first 70 and second 71 mesh surfaces. Taking the second surface normal Nᵢᵢ, the only valid intersection with any mesh surface is with a mesh face 74e of the first mesh surface 70, since this lies within the valid range defined by the ratio t/LS. The ray r₂ may be projected around the surface normal Nᵢᵢ forming a cone with an apex angle α₂ as a function of the local mesh size LS at the second source point S₂. However, in this example, the closest intersection point is the target point T⁰₂₀ as:

$$‖ ( {T}_{20}^{0} + ε d - {S}_{2} ) ‖ > ‖ {T}_{20}^{0} - {S}_{2} ‖$$

For sufficiently small value of ε, if d is an arbitrary unit vector that is tangent to the first mesh surface 70 at T⁰₂₀. ε is a tolerance determined by the user based upon the CAD model and system parameters. Thus, the only projection required from S₂ is S₂→T⁰₂₀.

Taking FIG. 7c, a third source point S₃ is selected as the mesh vertex 73c forming the first 90° elbow 75 in the first mesh surface 70. There are two surface normals N_{i, ii} associated with the first source point S₃: the first is parallel to the mesh face 77b, pointing away from the double 90° double elbow region, and the second is perpendicular to the mesh face 77b pointing away from the first 90° elbow 75 on the first mesh surface 70. Taking the first surface normal Nᵢ, there is no valid intersection with the first mesh surface 70 within the valid range given by the ratio t/LS, since this surface normal Nᵢ lies within the space separating the first 70 and second 71 mesh surfaces. Taking the second surface normal Nᵢᵢ, the only valid intersection with any mesh surface is with a mesh face 78b of the second mesh surface 71, since this lies within the valid range defined by the ratio t/LS. The ray r₃ may be projected around the surface normal Nᵢ forming a cone with an apex angle α3 as a function of the local mesh size LS at the third source point S₃. However, in this example, the closest intersection point is the target point T⁰₃₀ as:

$$‖ ( {T}_{30}^{0} + ε d - {S}_{3} ) ‖ > ‖ {T}_{30}^{0} - {S}_{3} ‖$$

For sufficiently small value of ε, if d is an arbitrary unit vector that is tangent to the first mesh surface 70 at T⁰₃₀. The only projection required from S₃ is S₃→T⁰₃₀.

FIG. 7d illustrates the situation once the Sᵢ→Tᵢ pairs set for all vertices and the region of the double 90° elbow pipe 72 has been explored to determine if there are any locally thin sections. There is a resulting topology that allows an anisotropic prismatic volume mesh to be generated in the regions of the double 90° elbow pipe 72 either side of the two 90° elbows. However, the region between the two 90° elbows is shown to be locally not thin, since no intersections with an opposing surface were found in this area. This then requires the generation of an isotropic volume mesh in order to fill the space within the double 90° elbow pipe completely.

There are other topological considerations that may prevent the generation of a prismatic volume mesh in the locally thin region, but these are also highlighted using the method 600 of embodiments. FIG. 7e illustrates the same double 90° elbow pipe arrangement as in FIG. 7a-7d with the addition of a multi-layered prismatic volume mesh in the regions previously determined as locally thin. Any attempt to fill the locally non-thin region with a multi-layered prismatic volume mesh would lead to highly skewed, anisotropic cells within the volume mesh, with two small regions A and B in the corners of the double 90° elbow connecting section where an unstructured volume mesh would be required. Regardless of the type of numerical simulation following the volume mesh generation, such as structural analysis or computational flow dynamics (CFD), it is more reasonable to fill the entire locally non-thin cavity with an isotropic volume mesh to achieve the optimum results.

2. Double 90° Elbow Pipe with Corner Cut

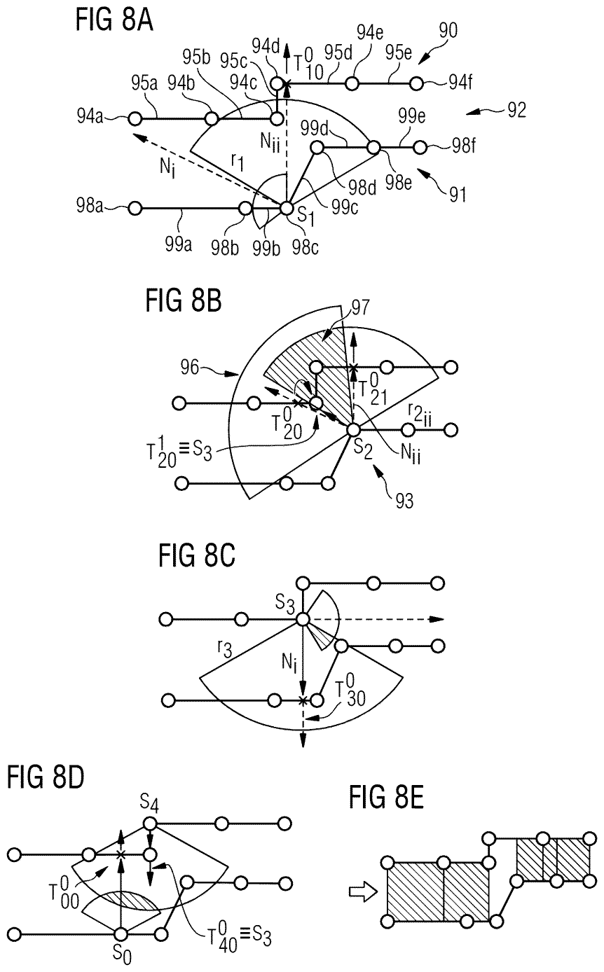

FIGS. 8a to 8d illustrate the application of a method in accordance with an embodiment to a pair of opposing, proximate mesh surfaces forming a double 90° elbow pipe with a corner cut, and FIG. 8e is a schematic illustration of the results of the application of the method in FIGS. 8a to 8d. In each of FIGS. 8a to 8e, a pair of proximate, opposing mesh surfaces 90, 91 in a double 90° elbow pipe 92 are shown. However, this arrangement differs from that shown in FIGS. 7a to 7d in that a corner cut has been provided in that a corner cut 93 has been provided by shortening the distance between two mesh vertices 98b, 98c in the second mesh surface 91. The first mesh surface 90 retains the first and second 90° elbows 96, 97 but the second 90° elbow is absent in the second mesh surface 91, where the mesh vertices 98c, 98d now sit between mesh faces defining an obtuse dihedral angle. The pipe 92 still however has a locally altered diameter within the region of the first and second 90° elbows 96, 97, and is continuous without a break along its length as shown. Again, source points S for exploration of the double 90° elbow region are chosen based on the mesh vertices that border the region itself.

In FIG. 8a, the first surface normal Nᵢ does not intersect the first mesh surface 90 within the valid range of t/LS for the first source point S₁. The second surface normal Nᵢᵢ reaches a target point T⁰₁₀ on the first mesh surface 90 outside of the valid range of t/LS, and will be discarded as the gap between the edge of the cone indicating the valid range and the first mesh surface 90 is greater than a reasonable tolerance ε.

FIG. 8b shows the situation where rays projected along both surface normals N_{i, ii} intersect the first mesh surface 90 at target points within the valid range of t/LS at a second source point S₂. The second source point S₂ is selected at the mesh vertex 98d at the upper end of the cut-off corner, where the adjoining mesh faces 99c, 99d define an obtuse dihedral angle. Taking a first surface normal Nᵢ, this intersects the first mesh surface 90 at an angle to a mesh face 95b adjacent to a mesh vertex 94c to form the target point T⁰₂₀. However, S₂→T⁰₂₀ is not stable with respect to the shortest source point-target point distance, and therefore relies on an inherent snapping property that is induced by the closest point projection within the cone created from projecting a ray r₂ᵢ along the first surface normal Nᵢ. The intersection is moved to a second target point T¹₂₀, where the superscript “1” denotes that this is a new target point within the original cone based upon the first surface normal Nᵢ, since S₂→T¹₂₀ is stable with respect to the shortest source point-target point distance. The snapping effect is the result of using the concept of the closest point lookup within the method 600, and therefore requires no specific hardcoding to be provided. A ray r₂ᵢᵢ projected based on the second surface normal Nᵢᵢ at S₂ also intersects the first mesh surface 90 at a target point T⁰₂₁. Since this is already the shortest source point-target point distance for the cone based on this ray projection, there is no need to carry out any snapping or further exploration and the final projection will be S₂→T⁰₂₁.

FIG. 8c shows perhaps the simplest situation where again, similar to FIG. 7c, a single projection from a third source point S₃ placed at a vertex 94c on the first mesh surface 90 (which was also a target point T¹₂₀ for the second source point S₂) to an intersection with the second mesh surface 91 on a mesh face 99b at a target point T⁰₃₀. While the method 600 searches for the closest intersection point within the cone with respect to the initial intersection point, the target point T⁰₃₀ is already stable, making the final projection S₃→T⁰₃₀.

Finally, turning to FIG. 8d, the remaining possible source points around the 90° elbow region are considered to provide that the exploration of whether or not this region is locally thin are complete. Taking a source point S₀ as being the first vertex 98b on the second mesh surface 91 adjacent the region of interest it is seen that a ray r₀ projected along the first surface normal N₁ intersects the first mesh surface 70 at a target point T⁰₀₀, which is within the valid region based on t/LS based on the length of the mesh surface 99a on the left-hand side of the source point S₀ as shown in the Figure. This makes the final projection S₀→T⁰₀₀. For the fourth source point S₄, located at the final vertex 94d on the first mesh surface 90 bordering the region of interest the only possible intersection that is stable is that where the target point T⁰₄₀ is snapped to the third source point S₃.

FIG. 8e illustrates the results of the exploration around the region of interest. The regions on either side of the 90° elbow are deduced to be locally thin, and therefore a prismatic volume mesh is generated in these regions. The central region bounded by the cut corner and the 90° elbow is found to be locally non-thin, and an isotropic volume mesh is generated here.

### 3. Double Sharp Elbow Pipe

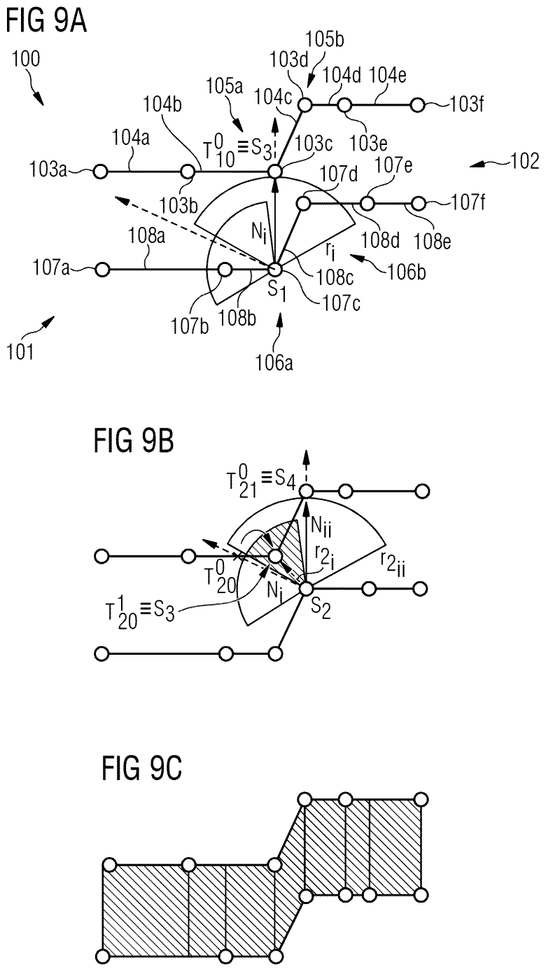

FIGS. 9a to 9b illustrate the application of a method in accordance with an embodiment to a pair of opposing, proximate mesh surfaces forming a double sharp elbow pipe, and FIG. 9c is a schematic illustration of the results of the application of the method in FIGS. 9a to 9b. In each of FIGS. 9a to 9c, a pair of proximate, opposing mesh surfaces 100, 101 in a double sharp elbow pipe 102 are shown. However, this arrangement differs from that shown in FIGS. 8a to 8e in that a vertex 103c in the first mesh surface 100 has been moved to replicate the positioning of the cut corner created by shortening the distance between two mesh vertices 107b, 107c in the second mesh surface 101. In both the first 100 and second mesh surfaces 101, the mesh vertices 103c, 103d, 107c, 107d now sit between mesh surfaces defining an obtuse dihedral angle. The pipe 102 still however has a locally altered diameter within the region of the first and second sharp elbows 105a, b, 106a, b, and is continuous without a break along its length as shown. Again, source points S for exploration of the double sharp elbow region are chosen based on the mesh vertices that border the region itself.

FIG. 9a illustrates the choice of a first source point S₁ as the mesh vertex 107c on the second mesh surface 101 where the first obtuse dihedral angle is defined by mesh faces 108b, 108c in the pipe 102. A ray r₁ projected along the first surface normal Nᵢ perpendicular to the second mesh surface 101 intersects the first mesh surface 100 at a first target point T⁰₁₀. This also happens to be a mesh vertex 105c on the first mesh surface 100 that may be regarded as the third source point S₃ based on its positioning on the boundary of the region of interest. The final projection is therefore Sᵢ→T⁰₁₀.

FIG. 9b illustrates a similar situation to FIG. 8c, where rays projected along both surface normals N_{i, ii} intersect the first mesh surface 100 at target points within the valid range of t/LS at a second source point S₂. The second source point S₂ is selected at the mesh vertex 107d at the upper end of the cut-off corner, where the adjoining mesh faces 108c, 108e define an obtuse dihedral angle. Taking a first surface normal Nᵢ, this intersects the first mesh surface 70 at an angle to a mesh face 75b adjacent to a mesh vertex 103c to form the target point T⁰₂₀. However, S₂→T⁰₂₀ is not stable with respect to the shortest source point-target point distance, and therefore relies on an inherent snapping property that is induced by the closest point projection within the cone created from projecting a ray r₂ᵢ along the first surface normal Nᵢ. The intersection is moved to a second target point T¹₂₀, where the superscript “1” denotes that this is a new target point within the original cone based upon the first surface normal Nᵢ, since S₂→T¹₂₀ is stable with respect to the shortest source point-target point distance. The snapping effect is the result of using the concept of the closest point lookup within the method 600, and therefore requires no specific hardcoding to be provided. A ray r₂ᵢᵢ projected based on the second surface normal Nᵢ at S₂ also intersects the first mesh surface 100 at a target point T⁰₂₁. Since this is already the shortest source point-target point distance for the cone based on this ray projection, there is no need to carry out any snapping or further exploration and the final projection will be S₂→T⁰₂₁. T⁰₂₁ also happens to correspond to the second mesh vertex 103d on the first mesh surface 100 that borders the region of interest, and therefore act as a fourth source point S₄. However, since the locally thin nature of the region of interest may be mapped easily from the ray projections from the first Sᵢ and second S₂ source points, there is no need to perform projections from these source points.

FIG. 9c illustrates the results of the exploration around the region of interest. It has been determined by the method 600 that all of the space between the two opposite and proximate mesh surfaces 100, 101 is locally thin, hence a prismatic volume mesh may be generated along the entire double sharp elbow pipe shown.

### 4. Double Sharp Elbow Pipe (Bottom Shifted)

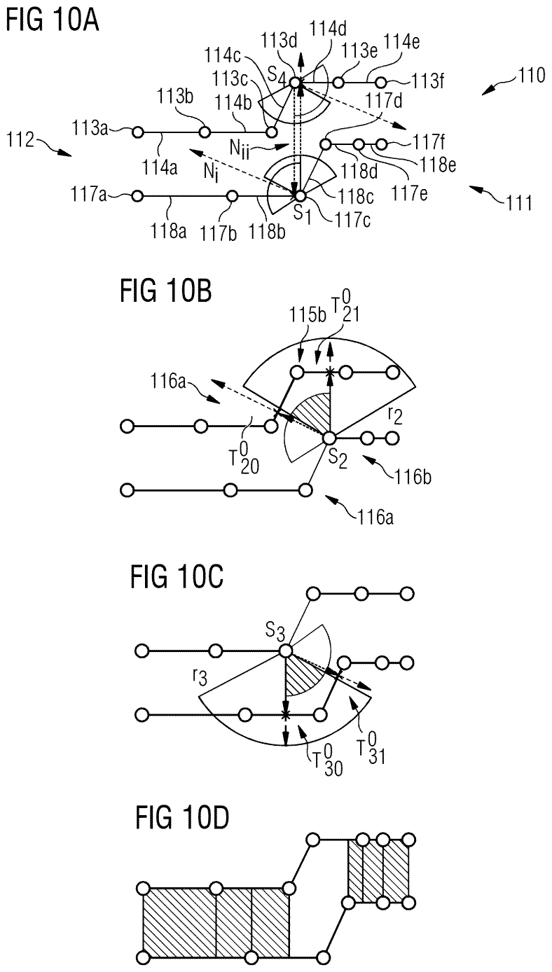

FIGS. 10a to 10c illustrate the application of a method in accordance with an embodiment to a pair of opposing, proximate mesh surfaces forming a double sharp elbow pipe with a bottom shift, and FIG. 10d is a schematic illustration of the results of the application of the method in FIGS. 10a to 10c. In each of FIGS. 10a to 10c, a pair of proximate, opposing mesh surfaces 110, 111 in a double sharp elbow pipe 112 with a bottom shift are shown. However, this arrangement differs from that shown in FIGS. 9a to 9c in that a vertex 113c in the first mesh surface 100 and the vertex 117c in the second mesh surface 111 have been moved to create two cut corners, resulting in a pipe 110 having an elbow at greater than 90°. The second mesh surface 111 has been shifted with respect to the first mesh surface 110 such that the sides of the pipe 112 in the elbow region are not parallel. In both the first 110 and second mesh surfaces 111, the mesh vertices 113c, 113d, 117c, 117d now sit between mesh surfaces defining an obtuse dihedral angle. The pipe 112 still however has a locally altered diameter within the region of the first and second sharp elbows 115, 116, and is continuous without a break along its length as shown. Again, source points S for exploration of the double sharp elbow region are chosen based on the mesh vertices that border the region itself.

FIG. 10a illustrates the choice of a first source point Sᵢ as the mesh vertex 117c on the second mesh surface 111 where the first obtuse dihedral angle is defined by mesh faces 118b, 118c in the pipe 112. A ray r₁ projected along the first surface normal Nᵢ perpendicular to the second mesh surface 111 at the vertex 117c does not intersect the first mesh surface 110. Similarly, a ray r₁ᵢ projected along the second surface normal Nᵢᵢ perpendicular to the second mesh surface 111 intersects the first mesh surface 110 but is rejected due to the value of the ratio t/LS. Therefore, there is no target within range. Similarly, for a fourth source point S₄ located at a mesh vertex 113d on the first mesh surface 110, there is no target within range.

FIG. 10b illustrates a second source point S₂ selected at the mesh vertex 117d at the upper end of the cut-off corner, where the adjoining mesh faces 118c, 118e define an obtuse dihedral angle. Taking a first surface normal Nᵢ, this does not intersect the first surface mesh 110. Taking a second surface normal Nᵢᵢ, this intersects the first mesh surface 110 at a mesh face 118c adjacent to a mesh vertex 113c to form the target point 1°20. This, in principle, is a legitimate projection but the procedure will likely discard it anyway as it would generate poor quality prisms in the mesh structure. For this reason, only S₂→T⁰₂₁ is kept, and this provides that the shapes of the prism generated are well-shaped and do not suffer from highly non-parallel top or bottom caps.

FIG. 10c illustrates a similar situation to FIG. 10a. A third source point S₃ selected at the mesh vertex 113c at the lower end of the cut-off corner, where the adjoining mesh faces 114c, 114e define an obtuse dihedral angle. Taking a first surface normal Nᵢ, this does not intersect the second surface mesh 111. Taking a second surface normal Nᵢᵢ, this intersects the second mesh surface 111 at a mesh face 118b adjacent to a mesh vertex 117c to form the target point T⁰₃₀. This, in principle, is a legitimate projection but the procedure will likely discard it anyway as it would generate poor quality prisms in the mesh structure. For this reason, only S₃→T⁰₃₁ is kept, and this provides that the shapes of the prism generated are well-shaped and do not suffer from highly non-parallel top or bottom caps.

FIG. 10d illustrates the resulting mesh construction, where a locally non-thin region has been determined to lie within the region of the sharp elbows of the first mesh surface 110 and the second mesh surface 111, meaning that no prismatic mesh is generated in this region.

### 5. Sharp-Smooth Elbow Pipe

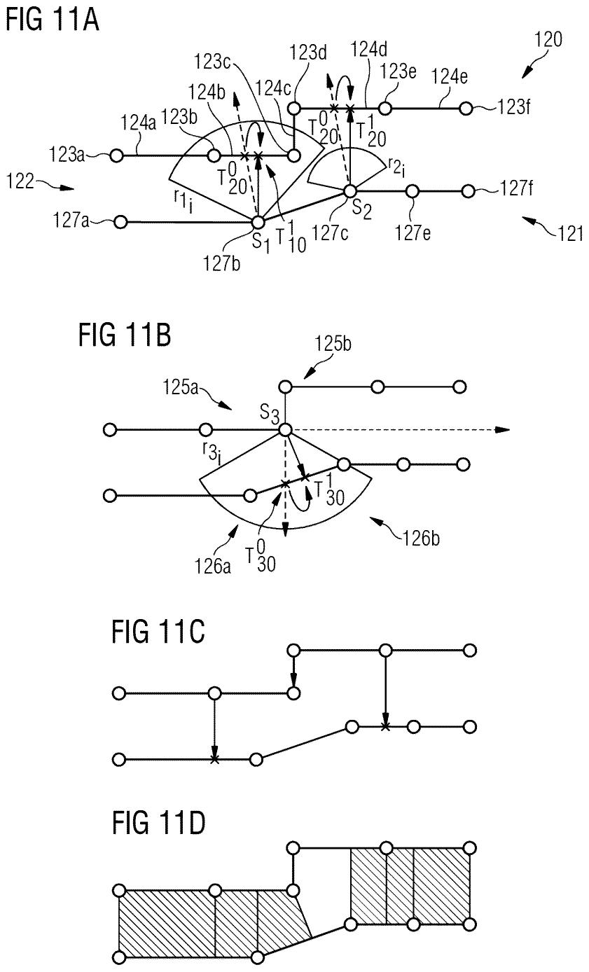

FIGS. 11a to 11c illustrate the application of a method in accordance with an embodiment to a pair of opposing, proximate mesh surfaces forming a sharp-smooth elbow pipe, and FIG. 11d is a schematic illustration of the results of the application of the method in FIGS. 11a to 11c. In each of FIGS. 11a to 11c, a pair of proximate, opposing mesh surfaces 120, 121 in a sharp-smooth elbow pipe 122 shown. This is where the first mesh surface 120 has two sharp, 90° elbows 125a, b and the second mesh surface 121 has two smooth, >90° elbows 126a, b. The pipe 122 still however has a locally altered diameter within the region of the sharp and smooth elbows 125a, b, 126a, b, and is continuous without a break along its length as shown. Again, source points S for exploration of the double sharp elbow region are chosen based on the mesh vertices that border the region itself.

FIG. 11a illustrates the choice of a first source point Sᵢ as the mesh vertex 117b on the second mesh surface 121. A first surface normal Nᵢ intersects the first mesh surface 120 at an angle to a mesh face 124b adjacent to a mesh vertex 123c to form the target point T⁰₁₀. However, S₁→T⁰₁₀ is not stable with respect to the shortest source point-target point distance, and therefore relies on an inherent snapping property that is induced by the closest point projection within the cone created from projecting a ray r₁ᵢ along the first surface normal Nᵢ. The intersection is moved to a second target point T⁰₁₀, where the superscript “1” denotes that this is a new target point within the original cone based upon the first surface normal Nᵢ, since S₁→T⁰₁₀ is stable with respect to the shortest source point-target point distance. The snapping effect is the result of using the concept of the closest point lookup within the method 600, and therefore requires no specific hardcoding to be provided. The final projection will be S₁→T⁰₁₀. A second source point S₂ is the mesh vertex 128c on the second mesh surface 121. Taking a first surface normal Nᵢ, this intersects the first mesh surface 90 at an angle to a mesh face 124d adjacent to a mesh vertex 123d to form the target point T⁰₂₀. However, S₂→T⁰₂₀ is not stable with respect to the shortest source point-target point distance, and therefore relies on an inherent snapping property that is induced by the closest point projection within the cone created from projecting a ray r₂ᵢ along the first surface normal Nᵢ. The intersection is moved to a second target point T¹₂₀, where the superscript “1” denotes that this is a new target point within the original cone based upon the first surface normal Nᵢ, since S₂→T¹₂₀ is stable with respect to the shortest source point-target point distance. The snapping effect is the result of using the concept of the closest point lookup within the method 600, and therefore requires no specific hardcoding to be provided. The final projection will be S₂→T¹₂₀.

FIG. 11b illustrates a second source point S₃ selected at the mesh vertex 123c on the first mesh surface 120 at the elbow. Taking a first surface normal Nᵢ, this does not intersect the second surface mesh 121. Taking a second surface normal Nᵢᵢ, this intersects the second mesh surface 121 at an angle to a mesh face 128b adjacent to a mesh vertex 123c to form the target point T⁰₃₀. However, S₃→T⁰₃₀ is not stable with respect to the shortest source point-target point distance, and therefore relies on an inherent snapping property that is induced by the closest point projection within the cone created from projecting a ray r₃ᵢ along the second surface normal Nᵢᵢ. The intersection is moved to a second target point T⁰₃₀, where the superscript “1” denotes that this is a new target point within the original cone based upon the second surface normal Nᵢᵢ, since S₃→T¹₃₀ is stable with respect to the shortest source point-target point distance. The snapping effect is the result of using the concept of the closest point lookup within the method 600, and therefore requires no specific hardcoding to be provided. The final projection will be S₃→T⁰₃₀.

FIG. 11c illustrates the resulting surface normals, and FIG. 11d the resulting mesh construction, where a locally non-thin region has been determined to lie within the region of the sharp elbow of the first mesh surface 120 and the smooth elbow of the second mesh surface 121, meaning that no prismatic mesh is generated in this region.

### 6. Smooth-Smooth Elbow

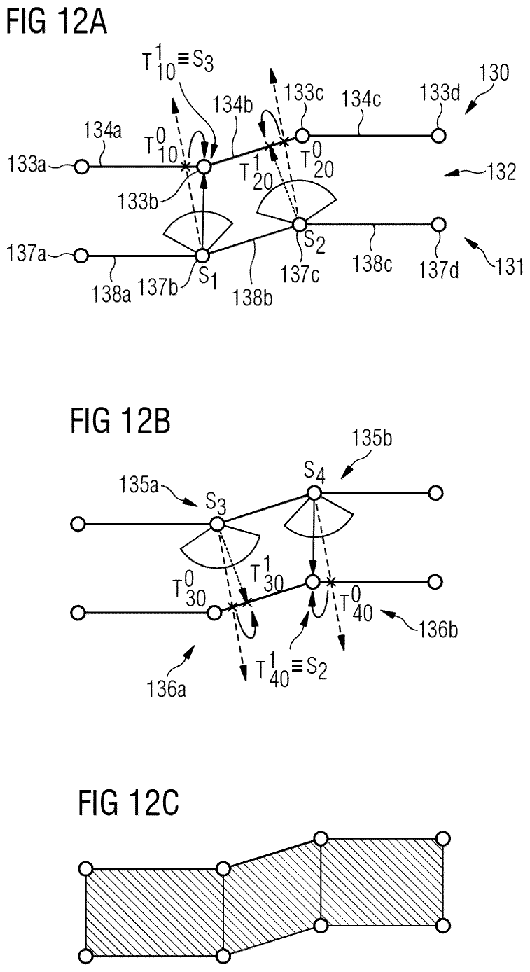

FIGS. 12a to 12b illustrate the application of a method in accordance with an embodiment to a pair of opposing, proximate mesh surfaces forming a smooth-smooth elbow pipe, and FIG. 12c is a schematic illustration of the results of the application of the method in FIGS. 12a to 12b. In each of FIGS. 12a to 12b, a pair of proximate, opposing mesh surfaces 130, 131 in a smooth-smooth elbow pipe 132 shown. This is where the first mesh surface 130 has two smooth elbows 135a, b and the second mesh surface 131 has two smooth elbows 136a, b. The pipe 132 still however has a locally altered diameter within the region of the sharp and smooth elbows 135a, b, 136a, b, and is continuous without a break along its length as shown. Again, source points S for exploration of the double sharp elbow region are chosen based on the mesh vertices that border the region itself.

FIG. 12a illustrates the choice of a first source point Sᵢ as the mesh vertex 137b on the second mesh surface 131. A first surface normal Nᵢ intersects the first mesh surface 130 at an angle to a mesh face 134a adjacent to a mesh vertex 133b to form the target point T⁰₁₀. However, S₁→T⁰₁₀ is not stable with respect to the shortest source point-target point distance, and therefore relies on an inherent snapping property that is induced by the closest point projection within the cone created from projecting a ray r₁ᵢ along the first surface normal Nᵢ. The intersection is moved to a second target point T⁰₁₀, where the superscript “1” denotes that this is a new target point within the original cone based upon the first surface normal Nᵢ, since S₁→T⁰₁₀ is stable with respect to the shortest source point-target point distance. The snapping effect is the result of using the concept of the closest point lookup within the method 600, and therefore requires no specific hardcoding to be provided. The final projection will be S₁→T⁰₁₀. A second source point S₂ is chosen as the mesh vertex 137c on the second mesh surface 131. A first surface normal Nᵢ intersects the first mesh surface 130 at an angle to a mesh face 133b adjacent to a mesh vertex 132c to form the target point T⁰₂₀. However, S₂→T⁰₂₀ is not stable with respect to the shortest source point-target point distance, and therefore relies on an inherent snapping property that is induced by the closest point projection within the cone created from projecting a ray r₂ᵢ along the first surface normal Nᵢ. The intersection is moved to a second target point T¹₂₀, where the superscript “1” denotes that this is a new target point within the original cone based upon the first surface normal Nᵢ, since S₂→T¹₂₀ is stable with respect to the shortest source point-target point distance. The snapping effect is the result of using the concept of the closest point lookup within the method 600, and therefore requires no specific hardcoding to be provided. The final projection will be S₂→T⁰₂₁. It may also be seen at this point that the vector T⁰₁₀ is identically equal to the third source point S₃.

FIG. 12b illustrates taking the third source point S₃ is the mesh vertex 133b on the first mesh surface 130, the first surface normal Nᵢ, this intersects the second mesh surface 131 at an angle to a mesh face 138b adjacent to a mesh vertex 133b to form the target point T⁰₃₀. However, S₃→T⁰₃₀ is not stable with respect to the shortest source point-target point distance, and therefore relies on an inherent snapping property that is induced by the closest point projection within the cone created from projecting a ray r₃ᵢ along the first surface normal Nᵢ. The intersection is moved to a second target point T¹₃₀, where the superscript “1” denotes that this is a new target point within the original cone based upon the first surface normal Nᵢ, since S₃→T¹₃₀ is stable with respect to the shortest source point-target point distance. The snapping effect is the result of using the concept of the closest point lookup within the method 600, and therefore requires no specific hardcoding to be provided. The final projection will be S₃→T⁰₃₀. Finally, a fourth source point S₄ is chosen as the mesh vertex 133c on the first mesh surface 130, the first surface normal Nᵢ, this intersects the second mesh surface 131 at an angle to a mesh face 138c adjacent to a mesh vertex 137b to form the target point T⁰₄₀. However, S₄→T⁰₄₀ is not stable with respect to the shortest source point-target point distance, and therefore relies on an inherent snapping property that is induced by the closest point projection within the cone created from projecting a ray r₄ᵢ along the first surface normal Nᵢ. The intersection is moved to a second target point T⁰₄₀, where the superscript “1” denotes that this is a new target point within the original cone based upon the first surface normal Nᵢ, since S₄→T⁰₄₀ is stable with respect to the shortest source point-target point distance. The snapping effect is the result of using the concept of the closest point lookup within the method 600, and therefore requires no specific hardcoding to be provided. The final projection will be S₄→T⁰₄₀.

FIG. 12c illustrates the resulting mesh construction, where a locally thin region has been determined to lie within the region of the smooth elbows of the first mesh surface 130 and the second mesh surface 131, meaning that a prismatic mesh is generated in this region.

### 7. Smooth-Smooth Elbow (Bottom Shifted)

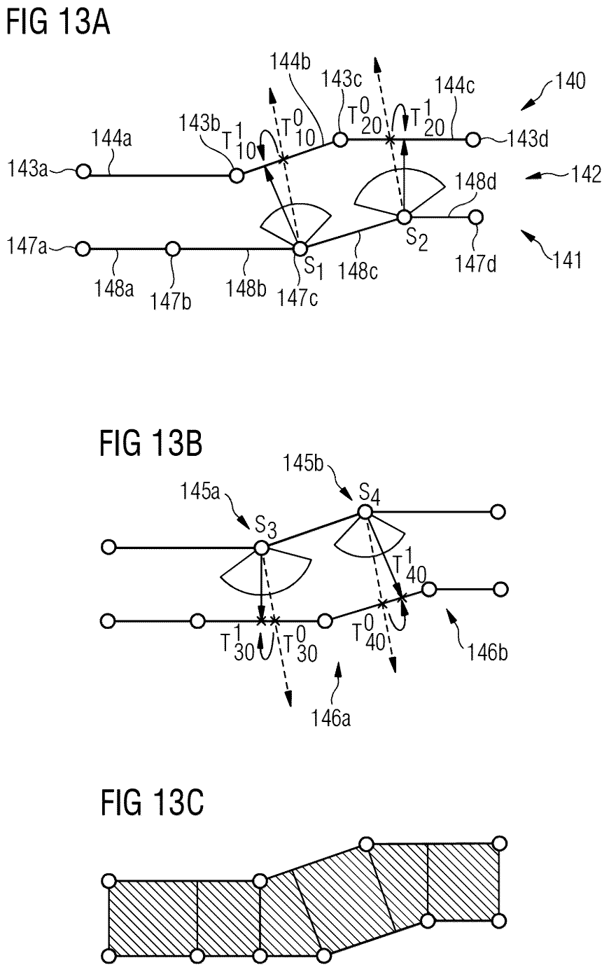

FIGS. 13a to 13b illustrate the application of a method in accordance with an embodiment to a pair of opposing, proximate mesh surfaces forming a smooth-smooth elbow pipe where one of the mesh surfaces has been shifted with respect to the other, and FIG. 13c is a schematic illustration of the results of the application of the method in FIGS. 13a to 13b. In each of FIGS. 13a to 13b, a pair of proximate, opposing mesh surfaces 140, 141 in a smooth-smooth elbow bottom-shifted pipe 142 shown. This is where the first mesh surface 140 has two smooth elbows 145a, b and the second mesh surface 141 has two smooth elbows 146a, b, but these have been shifted with respect to each other. The pipe 142 still however has a locally altered diameter within the region of the sharp and smooth elbows 145a, b, 146a, b, and is continuous without a break along its length as shown. Again, source points S for exploration of the double sharp elbow region are chosen based on the mesh vertices that border the region itself.

FIG. 13a illustrates the choice of a first source point Sᵢ as the mesh vertex 147b on the second mesh surface 141. A first surface normal Nᵢ intersects the first mesh surface 140 at an angle to a mesh face 144c adjacent to a mesh vertex 143b to form the target point T⁰₁₀. However, S₁→T⁰₁₀ is not stable with respect to the shortest source point-target point distance, and therefore relies on an inherent snapping property that is induced by the closest point projection within the cone created from projecting a ray r₁ᵢ along the first surface normal Nᵢ. The intersection is moved to a second target point T⁰₁₀, where the superscript “1” denotes that this is a new target point within the original cone based upon the first surface normal Nᵢ, since S₁→T⁰₁₀ is stable with respect to the shortest source point-target point distance. The snapping effect is the result of using the concept of the closest point lookup within the method 600, and therefore requires no specific hardcoding to be provided. The final projection will be S₁→T⁰₁₀. A second source point S₂ is chosen as the mesh vertex 147c on the second mesh surface 141. A first surface normal Nᵢ intersects the first mesh surface 140 at an angle to a mesh face 144c adjacent to a mesh vertex 143d to form the target point T⁰₂₀. However, S₂→T⁰₂₀ is not stable with respect to the shortest source point-target point distance, and therefore relies on an inherent snapping property that is induced by the closest point projection within the cone created from projecting a ray r₂ᵢ along the first surface normal Nᵢ. The intersection is moved to a second target point T¹₂₀, where the superscript “1” denotes that this is a new target point within the original cone based upon the first surface normal Nᵢ, since S₂→1120 is stable with respect to the shortest source point-target point distance. The snapping effect is the result of using the concept of the closest point lookup within the method 600, and therefore requires no specific hardcoding to be provided. The final projection will be S₂→T⁰₂₁.

FIG. 13b illustrates taking the third source point S₃ is the mesh vertex 143b on the first mesh surface 140, the first surface normal Nᵢ, this intersects the second mesh surface 141 at an angle to a mesh face 148b adjacent to a mesh vertex 147b to form the target point T⁰₃₀. However, S₃→T⁰₃₀ is not stable with respect to the shortest source point-target point distance, and therefore relies on an inherent snapping property that is induced by the closest point projection within the cone created from projecting a ray r₃ᵢ along the first surface normal Nᵢ. The intersection is moved to a second target point T¹₃₀, where the superscript “1” denotes that this is a new target point within the original cone based upon the first surface normal Nᵢ, since S₃→T⁰₃₀ is stable with respect to the shortest source point-target point distance. The snapping effect is the result of using the concept of the closest point lookup within the method 600, and therefore requires no specific hardcoding to be provided. The final projection will be S₃→T⁰₃₀. Finally, a fourth source point S₄ is chosen as the mesh vertex 143c on the first mesh surface 140, the first surface normal Nᵢ, this intersects the second mesh surface 131 at an angle to a mesh face 148c adjacent to a mesh vertex 147b to form the target point T⁰₄₀. However, S₄→T⁰₄₀ is not stable with respect to the shortest source point-target point distance, and therefore relies on an inherent snapping property that is induced by the closest point projection within the cone created from projecting a ray rai along the first surface normal Nᵢ. The intersection is moved to a second target point T⁰₄₀, where the superscript “1” denotes that this is a new target point within the original cone based upon the first surface normal Nᵢ, since S₄→T₁_{₄₀} is stable with respect to the shortest source point-target point distance. The snapping effect is the result of using the concept of the closest point lookup within the method 600, and therefore requires no specific hardcoding to be provided. The final projection will be S₄→T⁰₄₀.

FIG. 13c illustrates the resulting mesh construction, where a locally thin region has been determined to lie within the region of the smooth elbows of the first mesh surface 140 and the second mesh surface 141, meaning that a prismatic mesh is generated in this region.

### 8. Convergent-Divergent Surfaces

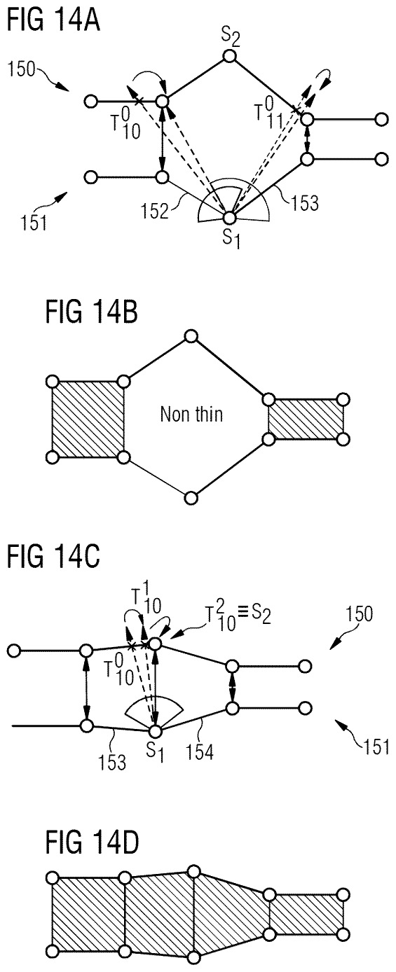

FIGS. 14a and b illustrate the effect of angle on convergent-divergent surfaces and identifying whether a mesh is locally thin. FIG. 14a illustrates a first mesh surface 150 and a second mesh surface 151 that diverge from each other, and where a vertex S₂ in the first mesh surface 150 and a vertex Sᵢ in the second mesh surface 151 are positioned opposite one another at the point of greatest divergence between the first mesh surface 150 and the second mesh surface 151. The angle between the vertex face normals Nᵢ, Nᵢ of the faces 152, 153 either side of the vertex Sᵢ is large, such that the projections from S₁ tend to diverge with respect to S₂. As illustrated in FIG. 14b, this creates a cavity in the prismatic mesh.

FIG. 14c illustrates a first mesh surface 150 and a second mesh surface 151 that diverge from each other, and where a vertex S₂ in the first mesh surface 150 and a vertex S₁ in the second mesh surface 151 are positioned opposite one another at the point of greatest divergence between the first mesh surface 150 and the second mesh surface 151. The angle between the vertex face normals Nᵢ, Nᵢ of the faces 152, 153 either side of the vertex S₁ is smaller than in FIG. 14a, such that only one normal direction Nᵢ is associated with each of S₂ and S₁, allowing snapping to the nearest vertex of the opposite mesh surface. Since T²₁₀ is identically equal to Sᵢ such that S₁↔S₂, a prismatic mesh is generated, as illustrated in FIG. 14d.

### 9. Very Sharp Angles

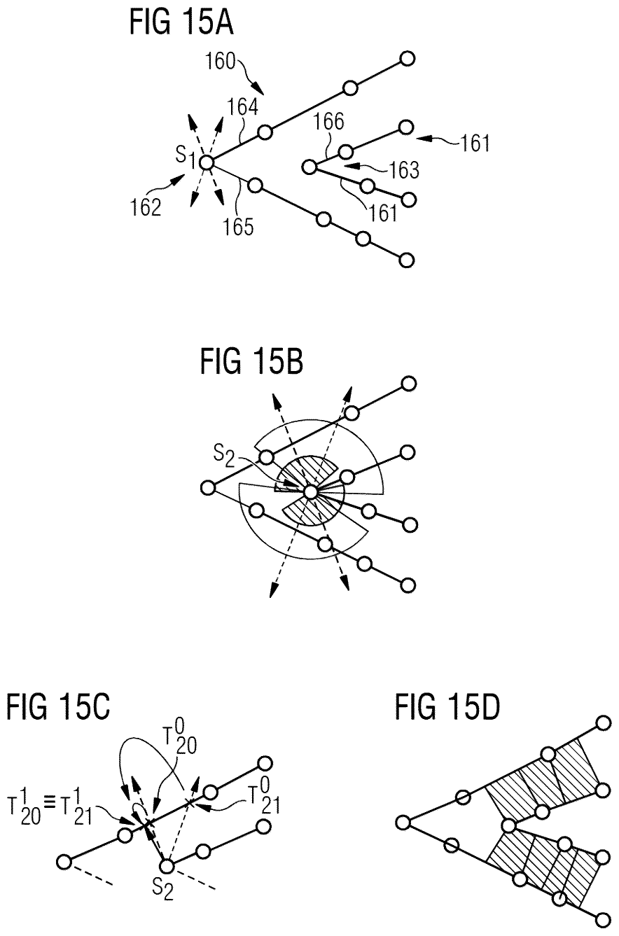

There are real-world cases that show sequences of nested geometries containing mirrored sharp angles. These are illustrated in FIGS. 15a to 15d, which show opposing mesh surfaces having mirrored sharp angles. FIG. 15a illustrates two opposing mesh surfaces including an outer mesh surface 160 and an inner mesh surface 161 each having a sharp angle 162, 163. This results in a “V”-shaped pipe, and as illustrated in FIG. 15a, a first source point Sᵢ chosen to lie at the vertex forming the point of the “V”-shape in the outer mesh surface 160 is projected along four directions, based upon two vertex subsets for each of the adjacent mesh faces 164, 165. Each of these surface normals Nᵢₙ returns no intersections with the opposing mesh surface 161. However, taking a second source point S₂ as the vertex forming the point of the “V”-shape in the inner mesh surface 161, it may be seen of the four surface normals Nᵢₙ generated from the two adjacent mesh faces 166, 167, four intersections are found, as illustrated in FIG. 15b. In FIG. 15c, of these, the intersection point T⁰₂₀ is unstable, and therefore snapped to the new intersection point T¹₂₀, and the intersection point T⁰₂₁ is also unstable, and snaps to the new intersection point T¹₂₁. Both T¹₂₀ and T¹₂₁ are identically equal to one another, resulting in two of the four projections being effectively redundant, and, as illustrated in FIG. 15d, a locally non-thin region is determined to lie in the region of the “V”-shaped pipe forming the apex of the “V”-shape.

The above-described embodiments, for performing proximity searches, has a number of advantages over existing systems. These include the ability of carry out multi-directional proximity searching and automatic thin region prismatic mesh generation. For multi-directional proximity searching, the embodiments described above enable the exploration of the space near a given source location to find any other proximate surface, which in turn may be utilized to solve a range of proximity problems in mesh generation. The automatic generation of a prismatic mesh provides a means for generating source-to-target pairs that may be used for volume discretization by prismatic or hexahedral cells in thin regions of arbitrary geometry. This allows the subsequent modelling of article behavior or the manufacture of an article containing the generated mesh to be far more accurate and realistic than otherwise possible.

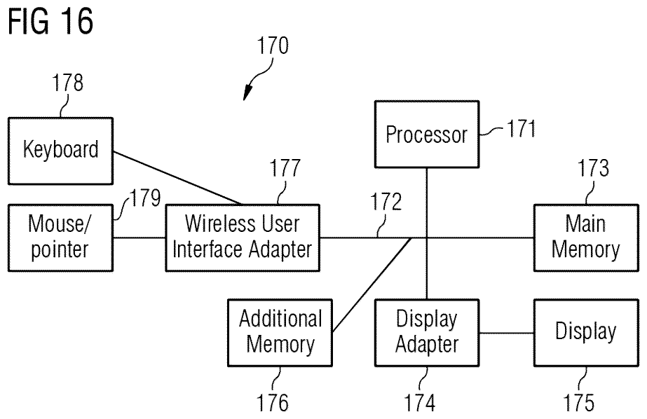

FIG. 16 illustrates an example of a data processing system in which an embodiment of the present disclosure may be implemented, for example a CAD system configured to perform processes as described herein. The data processing system 170 includes a processor 171 connected to a local system bus 172. The local system bus connects the processor to a main memory 173 and graphics display adaptor 174, which may be connect-ed to a display 175. The data processing system may communicate with other systems via a wireless user interface adapter connected to the local system bus 172, or via a wired network, for example, to a local area network. Additional memory 176 may also be connected via the local system bus. A suitable adaptor, such as wireless user interface adapter 177, for other peripheral devices, such as a keyboard 178 and mouse 179, or other pointing device, allows the user to provide input to the data processing system. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, certain devices referred to as input devices or output devices may both provide inputs and receive outputs of communications with the data processing system. Further, other peripheral hardware connected to the I/O controllers may include any type of device, ma-chine, or component that is configured to communicate with a data processing system.

An operating system included in the data processing system enables an output from the system to be displayed to the user on display 175 and the user to interact with the system. Examples of operating systems that may be used in a data processing system may include Microsoft Windows™, Linux™, UNIX™, iOS™, and Android™ operating systems.

In addition, the data processing system 170 may be implemented as in a networked environment, distributed system environment, virtual ma-chines in a virtual machine architecture, and/or cloud environment. For example, the processor 171 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 170 may vary for particular implementations. For example, the data processing system 170 in this example may correspond to a computer, workstation, and/or a server. However, alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a con-troller discussed herein. The depicted example is provided for the purpose of explanation only and is not meant to imply architectural limitations with respect to the present disclosure.

The data processing system 170 may be connected to the network (not a part of data processing system 170), which may be any public or private data processing system net-work or combination of networks, as known to those of skill in the art, including the Inter-net. Data processing system 170 may communicate over the network with one or more other data processing systems such as a server (also not part of the data processing system 170). However, an alternative data processing system may correspond to a plurality of data processing systems implemented as part of a distributed system in which processors associated with several data processing systems may be in communication by way of one or more network connections and may collectively perform tasks described as being per-formed by a single data processing system. Thus, it is to be understood that when referring to a data processing system, such a system may be implemented across several data processing systems organized in a distributed system in communication with each other via a network.

1. A computer-implemented method of generating a volume mesh between two mesh surfaces of a three-dimensional object in a modelling system, wherein the two mesh surfaces are proximate, disjoint, and opposing mesh surfaces, and wherein the modelling system is configured to render an image of the three-dimensional object comprising the two mesh surfaces to a user, the method comprising:
a) selecting a source point lying on a first mesh surface of the two mesh surfaces;
b) projecting a volume centered at the source point along an axis corresponding to a surface normal at the source point;
when the projected volume meets a second, opposing mesh surface of the two mesh surfaces along an axis of the opposing mesh surface within a distance determined by a value of a ratio t/LS, where LS is a local mesh size at the source point and t is a distance between the two mesh surfaces at the source point:
c) determining, within a region, a closest intersection point on the opposing mesh surface to the source point; and
d) generating a first volume mesh between the two mesh surfaces using the closest intersection point and the source point as vertices; and
when the projected volume does not meet the second, opposing mesh surface of the two mesh surfaces along the axis of the opposing mesh surface within the distance determined by the value of the ratio t/LS:
e) generating a second, different topology, volume mesh between the two mesh surfaces.

2. The method of claim 1, wherein the first volume mesh is a prismatic volume mesh, and
wherein the second volume mesh is an isotropic volume mesh.

3. The method of claim 1, wherein the source point lies at a vertex of the first mesh surface.

4. The method of claim 3, further comprising:
repeating acts a) to e) for all other vertices in the first mesh surface.

5. The method of claim 3, wherein the projected volume is a cone having an apex at the source point, and
wherein the cone is generated by projecting a ray along the surface normal at the source point and generating an apex angle as a function of the local mesh size.

6. The method of claim 5, wherein the determining of the closest intersection point comprises:
exploring the opposing mesh surface within the cone by projecting a ray k times, such that the closest intersection point is either an initial closest intersection point or a new intersection point obtained on a k^{th} ray projection that lies closer to the source point than the initial closest intersection point.

7. The method of claim 3, wherein the vertex is located at a change in direction of the first mesh surface.

8. The method of claim 1, wherein, when the closest intersection point on the opposing mesh surface lies within a pre-determined threshold distance of an adjacent mesh edge or vertex of the opposing mesh surface, the closest intersection point is moved to the adjacent mesh edge or vertex.

9. The method of claim 3, wherein, when the source point is bounded by n mesh vertices, the method further comprises:
selecting each vertex in turn as a respective source point; and
repeating acts a) to d) for each source point to determine the closest intersection point.

10. The method of claim 3, wherein a magnitude of vector ∥T−S∥ is given by the value of the ratio t/LS within a given tolerance of mesh size, where T is the closest intersection point, S is the source point, LS is the local mesh size at the source point, and t is the distance between the two mesh surfaces at the source point.

11. The method of claim 3, wherein the projected volume is a cylinder.

12. The method of claim 1, wherein the source point is located on a mesh edge or within a mesh face.

13. A data processing system configured to generate a volume mesh between two mesh surfaces of a three-dimensional object in a modelling system, wherein the two mesh surfaces are proximate, disjoint, and opposing mesh surfaces, the data processing system comprising:
a processor configured to:
select a source point lying on a first mesh surface of the two mesh surfaces;
project a volume centered at the source point along an axis corresponding to a surface normal at the source point;
when the projected volume meets a second, opposing mesh surface of the two mesh surfaces along an axis of the opposing mesh surface within a distance determined by a value of a ratio t/LS, where LS is a local mesh size at the source point and t is a distance between the two mesh surfaces at the source point:
determine, within a region, a closest intersection point on the opposing mesh surface to the source point; and
generate a first volume mesh between the two mesh surfaces using the closest intersection point and the source point as vertices; and
when the projected volume does not meet the second, opposing mesh surface of the two mesh surfaces along the axis of the opposing mesh surface within the distance determined by the value of the ratio t/LS:
generate a second, different topology, volume mesh between the two mesh surfaces; and
a display configured to display a rendered image of the three-dimensional object comprising the two mesh surfaces to a user.

14. The data processing system of claim 13, wherein the first volume mesh is a prismatic volume mesh, and
wherein the second volume mesh is an isotropic volume mesh.

15. A computer program product comprising instructions that, when executed by a computer, cause the computer to:
select a source point lying on a first mesh surface of two mesh surfaces of a three-dimensional object in a modelling system, wherein the two mesh surfaces are proximate, disjoint, and opposing mesh surfaces;
project a volume centered at the source point along an axis corresponding to a surface normal at the source point;
when the projected volume meets a second, opposing mesh surface of the two mesh surfaces along an axis of the opposing mesh surface within a distance determined by a value of a ratio t/LS, where LS is a local mesh size at the source point and t is a distance between the two mesh surfaces at the source point:
determine, within a region, a closest intersection point on the opposing mesh surface to the source point; and
generate a first volume mesh between the two mesh surfaces using the closest intersection point and the source point as vertices; and
when the projected volume does not meet the second, opposing mesh surface of the two mesh surfaces along the axis of the opposing mesh surface within the distance determined by the value of the ratio t/LS:
generate a second, different topology, volume mesh between the two mesh surfaces.
